(19) United States
(12) Patent Application Publication
(10) Pub. No.: US 2006/0132754 A1
(43) Pub. Date: Jun. 22, 2006

(54) Hand-held laser distance measuring device with a pulse reflection mixing method

(75) Inventors: Torsten Gogolla, Schaan (DE); Andreas Winter, Rankweil (AT); Helmut Seifert, Serba (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/304,966

(22) Filed: Dec. 14, 2005

(30) Foreign Application Priority Data
Dec. 16, 2004 (DE) 10 2004 060619.6

(51) Int. Cl. G01C 3/08

(52) U.S. Cl. 356/5.11; 356/5.01; 356/5.15

(57) ABSTRACT

A hand-held pulse laser distance measuring device (1) and a pulse reflection mixing method both having an algorithm (3) which controls a microcontroller (2) and which serves to calculate the distance (X) to a measurement object (4) by at least two different time differences (τ₁,τ₂) between a measurement pulse (6) and a reference pulse (7) with a pulse width (Δt), which time differences (τ₁, τ₂) are measured with a pulse repetition frequency (f₁, f₂), respectively, wherein a selection module (5) is provided which selects at least the first pulse repetition frequency (f₁) from at least a first frequency amount ({f}₁) with at least one other pulse repetition frequency (f₁ᵢ) in such a way that the amount of the relative time difference |τ·f₁| between the reference pulse (7) and the measurement pulse (6) with respect to the period (1/f₁) is greater than a lower limit (A) which is at least greater than twice the relative pulse width |Δt f₁| with respect to the period (1/f₁).

### BACKGROUND OF THE INVENTION

1. Field of the Invention

The invention relates to a hand-held laser distance measuring device with a pulse reflection mixing method, in particular a hand-held construction laser distance measuring device.

2. Description of the Prior Art

In the building industry, distances must be exactly determined with an accuracy of within a few mm at a range of up to several hundreds of meters distance. The hand-held laser distance measuring devices which are suitably constructed for this purpose and to which the present invention is directed use a pulse reflection mixing method of a modulated visible laser beam for measuring distance.

In EP610918B1, a short pulse train is used for distance measurement. After detection, this short pulse train excites an electronic resonator that is adapted to the pulse train frequency. The elevated signal of the resonator causes a laser to emit a new pulse train. This process is continuously repeated so that pulse cycles occur with a determined cycle frequency. The measured distance is determined by this cycle frequency.

DE3103567C2 introduces a method for direct measurement of the light pulse time-of-flight in which a measurement light pulse traveling over the measurement distance and a reference light pulse traveling over the reference distance are detected by the same photodetector. The detected measurement light pulse and reference light pulse start and stop a time measurement system, e.g., a fast counter. The measurement distance is determined definitively by means of direct and definitive measurement of the time difference between the detection of the reference light pulse and the detection of the measurement light pulse. The maximum repetition frequency of the light pulses is accordingly limited by the condition of the definitive determination of distance. However, it is disadvantageous that measurement is impossible when the measurement distance corresponds to one half of the reference distance because the two pulses overlap. This problem can be solved by using a switchable reference distance in the form of a light-conducting fiber so that a different reference distance can be selected in case of overlapping pulses.

DE 10112833C1 discloses a hand-held laser distance measuring device with a pulse reflection mixing method. The detection pulse train detected by the light detector or, in case of separate light detectors, the reference pulse train on the one hand and the measurement pulse train on the other hand are preferably directly subjected to direct mixing in the respective light detector followed by low-pass filtering. The direct mixing is controlled by a LO pulse train which is locally generated at the measurement point and whose duty factor is equal to, or approximately equal to, the duty factor of the measurement pulse train and whose repetition frequencies are selected so as to differ slightly. Accordingly, the mixing pulse repetition frequency f_{M} of the low-frequency pulse train corresponds to the amount of the difference between the pulse repetition frequency f of the transmission pulse train and measurement pulse train on the one hand and the pulse repetition frequency of the local oscillator pulse train f_{LO} on the other hand. Therefore: f_{M}=|f−f_{LO}|. Like the high-frequency detection pulse train, the low-frequency mixing pulse train likewise comprises reference pulses and measurement pulses whose time delay is a measure of the distance. For further particulars, the person skilled in the art is referred to the above-cited document, whose disclosure is explicitly incorporated herein in its entirety.

In hand-held laser distance measuring devices of the type mentioned above using a pulse reflection mixing method, commercially available laser diodes emitting in the visible red wavelength range are used as laser sources. The emitted laser light is modulated by a series of very narrow spike pulses—hereinafter, transmitting pulse train—and bundled into a measurement laser beam by a collimating lens. Accordingly, this special hand-held laser distance measuring device with pulse reflection mixing requires a series of very narrow laser pulses with a usual width of between 60 ps and 80 ps as transmitting pulse train. The pulse repetition frequency f of the laser pulses ranging from 50 MHz to 200 MHz is very high compared to the pulse repetition frequency of several tens of kHz found in conventional hand-held pulse laser distance measuring devices, so that it is generally impossible to determine distances definitively at a range of up to several hundreds of meters distance with one measurement at a determined fixed pulse repetition frequency. Therefore, at least two measurements with two substantially different pulse repetition frequencies or differences of pulse repetition frequencies f₁ and f₂, and for very great distance ranges with high accuracy, even n different pulse repetition frequencies, are needed for a definitive determination of distance. Using an algorithm, the microcontroller determines the time differences τₖ—generally in a nondefinitive manner—between the reference pulses and the measurement pulses of the low-frequency mixing pulses at different pulse repetition frequencies fₖ and, from the latter, determines the distance from the rangefinder to the light spot on the measurement object by means of the light velocity. At certain distances with a time difference τₖ=0, an overlapping of the reference pulse and measurement pulse results due to a finite pulse width Δt. Since this renders measurement impossible, the microcontroller in this case chooses a slightly different pulse repetition frequency fₖᵢ at which no overlapping occurs. It is disadvantageous that an increased distance measurement error must be taken into account even with a small τₖ because the two pulses influence one another due to the small distance.

In the following, the time difference between a reference pulse and a measurement pulse with respect to the period 1/fₖ is referred to as the relative time difference τ_{k·}fₖ and the pulse width with respect to the period 1/fₖ is referred to as the negative pulse width Δt·fₖ.

The object of the invention is to realize a hand-held laser distance measuring device with pulse reflection mixing having increased distance measuring accuracy. A further object is an algorithm for generating pulse repetition frequencies that are optimal with respect to distance measuring accuracy. SUMMARY OF THE INVENTION

These and other objects of the present invention, which will become apparent hereinafter are achieved by providing a hand-held pulse laser distance measuring device with pulse reflection mixing having an algorithm which controls a microcontroller and which serves to calculate the distance to a measurement object by at least two different time differences τ₁, τ₂ between a measurement pulse and a reference pulse, which time differences τ₁, τ₂ are measured with a pulse repetition frequency f₁, f₂, respectively, has a selection module which selects at least the first pulse repetition frequency f₁, from at least a first frequency amount {f}₁ with at least one other pulse repetition frequency f₁ᵢ in such a way that the amount of the relative time difference |τ_{1.}f₁| between a reference pulse and a measurement pulse with respect to the period 1/f₁, is greater than a lower limit A which is at least greater than twice the relative pulse width |Δt f₁| with respect to the period.

In the step preceding the calculation of the distance from the at least two time differences τ₁, τ₂ after the measurement of at least two time differences τ₁, τ₂ measured with different pulse repetition frequencies f₁, f₂, the associated measuring method has a selection step which selects at least the first pulse repetition frequency f₁ from at least a first frequency amount {f}₁ with at least one other pulse repetition frequency f₁ in such a way that the amount of the relative time difference |τ₁·f₁| between a reference pulse and a measurement pulse with respect to the period 1/f₁ is greater than a lower limit A which is at least greater than twice the relative pulse width |Δt f₁| with respect to the period.

By selecting a sufficiently suitable pulse repetition frequency, the mutual influence of the measurement pulse and the reference pulse is reduced to a minimum because interference such as post-oscillation has less impact at a sufficiently great interval between the measurement pulse and the reference pulse. The distance measuring accuracy is appreciably improved in this way.

The second pulse repetition frequency f₂ is advantageously selected from at least a second frequency amount {f}₂ with at least one other pulse repetition frequency f₂ᵢ in such a way that the amount of the relative time difference |τ_{2.}f₂| between a reference pulse and a measurement pulse with respect to the period 1/f₂ is greater than a lower limit A which is at least greater than twice the relative pulse width |Δt f₂| with respect to the period, so that the mutual influence of the two time differences needed for calculation is reduced.

With a quantity n of pulse repetition frequencies f₁. . . fₙ used for calculating the distance, a pulse repetition frequency fₖ, where k<=n, is advantageously selected in each instance from at least one other frequency amount {f}ₖ with at least one other pulse repetition frequency fₖᵢ in such a way that the amount of the time difference |τₖ·fₖ| between a reference pulse and a measurement pulse with respect to the period 1/fₖ is greater than a lower limit A which is at least greater than twice the relative pulse width Δt fₖ| with respect to the period, so that the mutual influence of all time differences needed for calculating large distances with high accuracy is reduced and the reliability of measurements is accordingly increased.

It is advantageous when at least one pulse repetition frequency fₖ is selected, and more advantageous when all pulse repetition frequencies fₖ are selected, in such a way that the amount |τₖ·fₖ₋½| is minimal so that optimal pulse repetition frequencies fₖ are used for the calculation.

The individual pulse repetition frequencies fₖᵢ in the frequency amount {f}ₖ are advantageously individual terms of a geometrical progression with a progression index i, i.e., for example, partial frequencies f₀ₖ/4, f_{Ok}/5, f₀ₖ/6 , . . . f₀ₖ/i derived from a reference frequency f₀ₖ, so that there is a strong convergence to a permissible time difference τₖᵢ in the measurement sequence as the progression index i increases.

The lower limit A for the selection of the pulse repetition frequency is advantageously greater than five-times the relative pulse width so that a sufficiently high distance measuring accuracy always results because of the sufficiently large pulse spacing.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a schematic view of a hand-held laser distance measuring device with algorithm; and

FIG. 2 a pulse train in normalized time scale.

### DETAILED DESCRIPTION OF THE PREFERRED EMBODIMENT

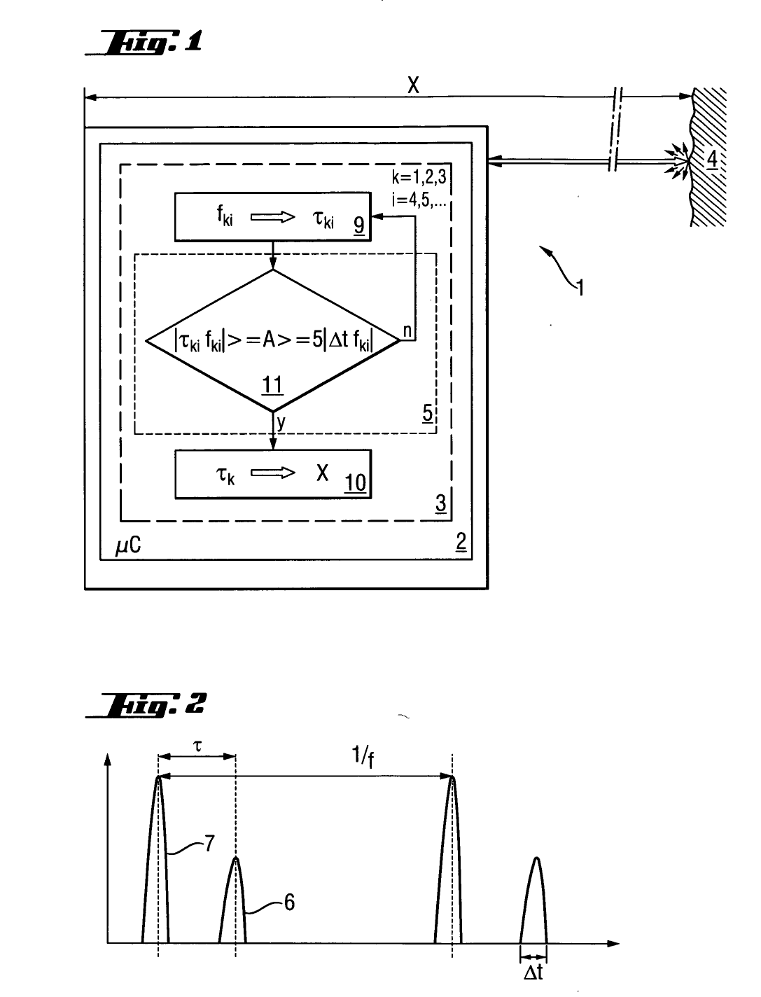

According to FIG. 1 and FIG. 2, a hand-held laser distance measuring device 1, shown schematically, with pulse reflection mixing has an algorithm 3 which controls a microcontroller 2 and which serves to calculate the distance X to a measurement object 4. The measurement of three time differences τ₁, τ₂, τ₃ between a measurement pulse 6 and a reference pulse 7 which are measured with substantially different pulse repetition frequencies f₁, f₂, f₃, where k=1, 2, 3 of the range index, is carried out in the algorithm 3 in a measurement step 9. In a subsequent calculation step 10, the distance X is calculated from the three time differences τ₁, τ₂, τ₃. In a selection step 11 of a selection module 5 of the algorithm 3 between the measurement step 9 and the calculation step 10, precisely the three different time differences τ₁, τ₂, τ₃ measured, respectively, with a different pulse repetition frequency f₁, f₂, f₃ are selected from a tested test progression of a frequency amount {f}₁, {f}₂, {f}₃ in such a way that each amount |τ₁·f₁−½|,|τ₂·f₂½| and |τ₃·f₃−½| is minimal, i.e., the scaled interval between the measurement pulse 6 and the reference pulse 7 is a maximum in each instance. Each of the frequency amounts
{f}1={400/4 MHZ, 400/5 MHZ, 400/6MHZ, . . .}={f₀₁/i},
{f}2={40/4 MHZ, 40/5 MHZ, 40/6 MHZ, . . . }={f₀₂/i}, and
{f}3={4/4 MHZ, 4/5 MHZ, 4/6 MHZ, . . .}={f₀₃/i}, contains individual pulse repetition frequencies fₖᵢ representing individual terms of a geometric progression with a progression index i=4, 5, 6, . . . which were derived in each instance from a reference frequency f₀₁=400 MHz, f₀₂=40 MHz and f₀₃=4 MHz as i-th partial frequencies. With the interrupt condition of the test progression of tested pulse repetition frequencies fₖᵢ per frequency amount {f}ₖ set at a permissible relative time difference |τₖᵢfₖᵢ|>=A>=5|Δfₖᵢ|, the selection module 5 contains, in addition, a lower limit A for calculating the distance X. For each frequency amount {f}ₖ, the first pulse repetition frequency fₖ which meets the above-stated interrupt condition automatically satisfies the condition that the amount |τₖ·fₖ−½| is minimal with respect to all of the tested pulse repetition frequencies fₖᵢ of the test progression.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held pulse laser distance measuring device with an algorithm (3) which controls a microcontroller (2) and which serves to calculate a distance (X) to a measurement object (4) by at least two different time differences (τ₁, τ₂) between a measurement pulse (6) and a reference pulse (7) with a pulse width (Δt), which time differences (τ₁, τ₂) are measured with a pulse repetition frequency (f₁, f₂), respectively, wherein the pulse laser distance measuring device includes a selection module (5) for selecting at least a first pulse repetition frequency (f₁ ) from at least a first frequency amount ({f}₁) with at least one other pulse repetition frequency (f₁ᵢ) in such a way that an amount of the relative time difference |τ₁·f₁| between the reference pulse (7) and the measurement pulse (6) with respect to the period (1/f₁) is greater than a lower limit (A) which is at least greater than twice the relative pulse width |Δt f₁| with respect to the period (1/f₁).

2. A pulse reflection mixing method for a hand-held laser distance measuring device (1) for calculating a distance (X) to a measurement object (4) with an algorithm (3) which is controlled by a microcontroller (2) with a measurement step (9) for measuring at least two time differences (τ₁, τ₂) between a measurement pulse (6) and a reference pulse (7) with a pulse width (Δt), which time differences (τ₁, τ₂) are measured with different pulse repetition frequencies (f₁, f₂), and a subsequent calculation step (10) for calculating the distance (X) from the at least two time differences (τ₁, τ₂), wherein the first pulse repetition frequency (f₁) is selected from at least a first frequency amount ({f}₁) with at least one other pulse repetition frequency (f₁ᵢ) in a selection step (11) of a selection module (5) between the measurement step (9) and the calculation step (10) in such a way that the amount of the relative time difference |τ₁·f₁| between the reference pulse (7) and the measurement pulse (6) with respect to the period (1/f₁) is greater than a lower limit (A) which is at least greater than twice the relative pulse width Δt f₁| with respect to the period (1/f_{l ).}

3. An algorithm for a hand-held pulse laser distance measuring device and which controls a microcontroller (2) and serves to calculate a distance (X) to a measurement object (4) by at least two different time differences (τ₁, τ₂) between a measurement pulse (6) and a reference pulse (7) with a pulse width (Δt), which time differences (τ₁, τ₂) are measured with a pulse repetition frequency (f₁, f₂), respectively, wherein the pulse laser distance measuring device includes a selection module (5) for selecting at least a first pulse repetition frequency (f₁) from at least a first frequency amount ({f}₁) with at least one other pulse repetition frequency (f₁ᵢ) in such a way that an amount of the relative time difference |τ₁·f₁| between the reference pulse (7) and the measurement pulse (6) with respect to the period (1/f₁) is greater than a lower limit (A) which is at least greater than twice the relative pulse width |Δt f₁| with respect to the period (1/f₁), wherein the second pulse repetition frequency (f₂) is selected from at least a second frequency amount {f}₂ with at least one other pulse repetition frequency (f₂ᵢ) in such a way that the amount of the relative time difference |τ₂·f₂| between the reference pulse (7) and the measurement pulse (6) with respect to the period (1/f₂) is greater than a lower limit (A) which is at least greater than twice the relative pulse width |Δt f₂| with respect to the period (1/f₂).

4. An algorithm for a pulse reflection mixing method for a hand-held laser distance measuring device (1) for calculating a distance (X) to a measurement object (4) with the algorithm (3) being controlled by a microcontroller (2) with a measurement step (9) for measuring at least two time differences (τ₁, τ₂) between a measurement pulse (6) and a reference pulse (7) with a pulse width (Δt), which time differences (τ₁, τ₂) are measured with different pulse repetition frequencies (f₁, f₂), and a subsequent calculation step (10) for calculating the distance (X) from the at least two time differences (τ₁, τ₂), wherein the first pulse repetition frequency (f₁) is selected from at least a first frequency amount ({f}₁) with at least one other pulse repetition frequency (f₁ᵢ) in a selection step (11) of a selection module (5) between the measurement step (9) and the calculation step (10) in such a way that the amount of the relative time difference |τ₁·f₁| between the reference pulse (7) and the measurement pulse (6) with respect to the period (1/f₁) is greater than a lower limit (A) which is at least greater than twice the relative pulse width |Δt f₁| with respect to the period (1/f₁), wherein the second pulse repetition frequency (f₂) is selected from at least a second frequency amount {f}₂ with at least one other pulse repetition frequency (f₂ᵢ) in such a way that the amount of the relative time difference |τ₂·f₂| between the reference pulse (7) and the measurement pulse (6) with respect to the period (1/f₂) is greater than a lower limit (A) which is at least greater than twice the relative pulse width |Δt f₂| with respect to the period (1/f₂).

5. An algorithm according to claim 3, wherein, with a quantity (n) of pulse repetition frequencies (f₁. . . fₙ) used for calculating the distance (X), where k=1 . . . n, a k-th pulse repetition frequency (fₖ) is selected in each instance from at least one k-th frequency amount ({f}ₖ) with at least one other pulse repetition frequency (fₖᵢ) in such a way that the amount of the relative time difference |τₖ·fₖ| between the reference pulse (7) and the measurement pulse (6) with respect to the period (1/fₖ) is greater than a lower limit (A) which is at least greater than twice the relative pulse width |τt fₖ| with respect to the period (1/fₖ).

6. An algorithm according to claim 4, wherein, with a quantity (n) of pulse repetition frequencies (f₁. . . fₙ) used for calculating the distance (X), where k=1 . . . n, a k-th pulse repetition frequency (fₖ) is selected in each instance from at least one k-th frequency amount ({f}ₖ) with at least one other pulse repetition frequency (fₖᵢ) in such a way that the amount of the relative time difference |τₖ·fₖ| between the reference pulse (7) and the measurement pulse (6) with respect to the period (1/fₖ) is greater than a lower limit (A) which is at least greater than twice the relative pulse width |Δt fₖ| with respect to the period (l/fₖ).

7. An algorithm according to claim 3, wherein in that the lower limit A for selecting the pulse repetition frequency is greater than five-times the relative pulse width |Δt fₖ|.

8. An algorithm according to claim 4, wherein in that the lower limit A for selecting the pulse repetition frequency is greater than five-times the relative pulse width |Δt fₖ|.

9. An algorithm according to claim 3, wherein at least one pulse repetition frequency (fₖ) is selected in such a way that the amount |τₖ·fₖ−½| is minimal in addition.

10. An algorithm according to claim 4, wherein at least one pulse repetition frequency (fₖ) is selected in such a way that the amount |τₖ·fₖ−½| is minimal in addition.

11. An algorithm according to claim 3, wherein the individual pulse repetition frequencies (fₖᵢ) in the frequency amount ({f}ₖ) are individual terms of a geometrical progression with a progression index (i).

12. An algorithm according to claim 4, wherein the individual pulse repetition frequencies (fₖᵢ) in the frequency amount ({f}ₖ) are individual terms of a geometrical progression with a progression index (i).
